(19) United States
(12) Patent Application Publication
(10) Pub. No.: US 2016/0321172 A1
(43) Pub. Date: Nov. 3, 2016

(54) MEMORY DEVICE THAT PERFORMS GARBAGE COLLECTION

(71) Applicant: KABUSHIKI KAISHA TOSHIBA, Tokyo (JP)

(72) Inventors: Akihide JINZENJI, Inagi Tokyo (JP); Katsuhiko UEKI, Katsushika Tokyo (JP)

(21) Appl. No.: 15/015,466

(22) Filed: Feb. 4, 2016

Related U.S. Application Data
(60) Provisional application No. 62/156,038, filed on May 1, 2015.

(51) Int. Cl. G06F 12/02

(52) U.S. Cl. CPC G06F 12/0253; G06F 12/0246; G06F 2212/7205; G06F 2212/7209

(57) ABSTRACT

A memory device includes a nonvolatile memory unit including a plurality of blocks, and a memory controller. The memory controller is configured to determine target blocks for garbage collection, and transfer valid data in the target blocks to another block during the garbage collection. The target blocks includes a first block that has a valid data ratio greater than zero and equal to or smaller than a predetermined value and a second block that has a valid data ratio greater than the predetermined value.

### CROSS-REFERENCE TO RELATED APPLICATION

This application is based upon and claims the benefit of priority from the U.S. Provisional Patent Application No. 62/156,038, filed May 1, 2015, the entire contents of which are incorporated herein by reference.

### FIELD

Embodiments relate generally to a memory device, in particular, a memory device that performs garbage collection.

### BACKGROUND

A memory device of one type includes a nonvolatile semiconductor memory and a controller that controls the semiconductor memory.

### BRIEF DESCRIPTION OF THE DRAWINGS

FIG. 1 is a perspective view of an information processing system according to a first embodiment.

FIG. 2 is a block diagram of a memory system according to the first embodiment.

FIG. 3 illustrates an equivalent circuit of block A of a NAND memory of the memory system in FIG. 2.

FIG. 4A illustrates data structure of a first block list stored in a buffer of the memory system according to the first embodiment.

FIG. 4B illustrates data structure of a second block list stored in the buffer.

FIG. 5 is a flowchart of generating and updating processing of the second block list according to the first embodiment.

FIG. 6 is a flowchart of garbage collection processing according to the first embodiment.

FIG. 7 schematically illustrates a step (S22) of the garbage collection processing according to the first embodiment.

FIG. 8 schematically illustrates a step (S26) of the garbage collection processing according to the first embodiment.

FIG. 9 is a timing chart illustrating a relationship between a processing time and latency of the garbage collection processing according to the first embodiment.

FIG. 10 illustrates data structure of a second block list according to a second embodiment.

FIG. 11 is a flowchart of generating and updating processing of the second block list according to the second embodiment.

FIG. 12 is a flowchart of garbage collection processing according to the second embodiment.

FIG. 13 illustrates data structure of a second block list according to a third embodiment.

FIG. 14 is a flowchart of generating and updating processing of the second block list according to the third embodiment.

FIG. 15 illustrates data structure of a second block list according to a fourth embodiment.

FIG. 16 is a flowchart of generating and updating processing of the second block list according to the fourth embodiment.

### DETAILED DESCRIPTION

In general, according to an embodiment, a memory device includes a nonvolatile memory unit including a plurality of blocks, and a memory controller. The memory controller is configured to determine target blocks for garbage collection, and transfer valid data in the target blocks to another block during the garbage collection. The target blocks includes a first block that has a valid data ratio greater than zero and equal to or smaller than a predetermined value and a second block that has a valid data ratio greater than the predetermined value.

Various embodiments will be described hereinafter with reference to the accompanying drawings. In the description below, substantially the same functions and elements are denoted by same reference numerals, and a description will be given only where necessary. Further, in the present disclosure, a plurality of expressions may be used for some elements. These expressions are merely illustrative examples, and these elements may be expressed by other expressions.

### First Embodiment

[1. Configuration]

[1-1. Overall Configuration (Information Processing System)]

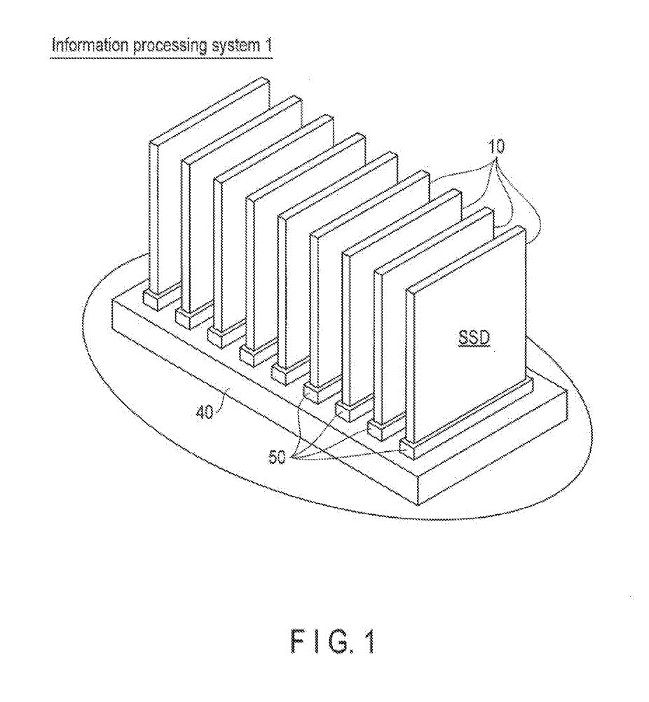

Referring to FIG. 1, an information processing system 1 according to a first embodiment is described. As shown in FIG. 1, the information processing system 1 according to the first embodiment includes a memory system (memory device) 10 and a host 40 which controls the memory system 10. Here, a solid-state drive (SSD) is described as an example of the memory system 10.

As shown in FIG. 1, an SSD 10 which is the memory system according to the first embodiment is a relatively small module. The outer-shape dimensions are, for instance, about 100 mm×150 mm. Here, the size and dimensions of the SSD 10 are not limited to these values, and proper changes to various sizes are possible.

Further, the SSD 10 can be used by being mounted in the host 40 such as a server, in a data center, a cloud computing system, or the like which is operated in a company (enterprise). Thus, the SSD 10 may be an enterprise SSD (eSSD).

The host (host apparatus) 40 includes a plurality of connectors (for example, slots) 50 which opens upward, for example. Each connector 50 is, for example, a Serial Attached SCSI (SAS) connector. According to this SAS connector, the host 40 and each SSD 10 can execute high speed communication by 6 Gbps dual ports. Here, each connector 50 is not limited to this, and may be, for instance, a PCI Express (PCIe) or an NVM Express (NVMe).

Further, the plural SSDs 10 are attached to the connectors 50 of the host 40, respectively, and are juxtaposed and supported upright in a substantially vertical direction. According to this configuration, the plural SSDs 10 can be mounted in a compact size, and the size of the host 40 can be reduced. The shape of each SSD 10 is a 2.5-inch small form factor (SFF). By this SFF shape, the SSD 10 can have a compatible shape with an enterprise HDD (eHDD). Thus, the SSD 10 has system compatibility with the eHDD.

In the meantime, the SSD 10 is not limited to the use for enterprises. For example, the SSD 10 is naturally applicable as a storage medium of a consumer electronic device such as a notebook portable computer or a tablet terminal.

[1-2. Memory System]

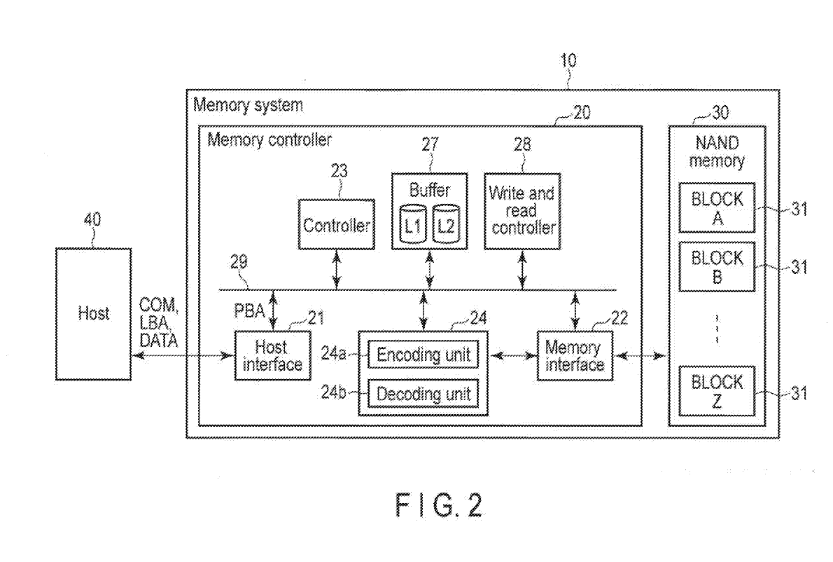

Referring to FIG. 2, the detailed configuration of the memory system (SSD) 10 according to the first embodiment is described.

As shown in FIG. 2, the memory system 10 according to the first embodiment includes a NAND flash memory (hereinafter referred to as a “NAND memory”) 30, and a memory controller 20 which controls the NAND memory 30.

The NAND memory 30 is a semiconductor memory which includes a plurality of blocks (blocks A to Z) 31, and stores data in each block 31 in a nonvolatile manner. The NAND memory 30 stores write data transmitted from the host 40 in the blocks 31 in accordance with control of the memory controller 20, and reads the stored data from the blocks 31. The NAND memory 30 erases the data stored in the blocks 31 in accordance with the control of the memory controller 20. The blocks 31 will be described in detail below.

The memory controller (controller, memory control unit) 20 controls the NAND memory 30 on the basis of a command COM, a logical address LBA, and data DATA, etc., transmitted from the host 40. The memory controller 20 includes a host interface 21, a memory interface 22, a controller 23, an encoding and decoding unit 24, a buffer 27, and a write and read controller 28, which are electrically connected to each other through a control line 29.

The host interface (host I/F) 21 transfers the command (write command, read command, and erase command, etc.) COM, the logical address LBA, and the data DATA, etc., between the memory controller 20 and the host 40. The host interface 21 may convert the logical address LBA transmitted from the host 40 to a predetermined physical address PBA using an address conversion table.

The memory interface (memory I/F) 22 transfers a command, write data, and read data, etc., between the memory controller 20 and the NAND memory 30.

The encoding/decoding unit 24 includes an encoding unit 24a and a decoding unit 24b. The encoding unit 24a generates an error correction code for write data transmitted from the host 40 during a data write operation. The decoding unit 24b corrects an error of read data transmitted from the NAND memory 30 using the error correction code during a data read operation.

The buffer (data storage) 27 stores the write data, the read data, and the first and second block lists L1 and L2, etc. More specifically, the buffer 27 temporarily stores data until the size of the write data transmitted from the host 40 reaches a predetermined data size that is suited to the NAND memory 30. For example, the buffer 27 temporarily stores the write data until the size of the data reaches 16 KB, which corresponds to a page size. Further, the buffer 27 temporarily stores the read data read from the NAND memory 30. More specifically, the read data stored in the buffer 27 is rearranged in an order suited to the host 40 (an order of the logical address LBA which is designated by the host 40).

Moreover, the buffer 27 stores the first and second block lists L1 and L2. The first and second block lists L1 and L2 are lists each indicating block information of blocks (garbage collection source blocks) from which data can be transferred during a garbage collection (or compaction). The first and second block lists L1 and L2 will be described in detail below.

The write and read controller 28 controls the data write operation and the data read operation in accordance with the controller 23. The write and read controller 28 writes the write data in the NAND memory 30 in parallel using a plurality of channels (for example, four channels) in order to meet a predetermined speed requirement, for example, in the data write operation.

The controller 23 controls the respective components (21, 22, 24, 27 and 28) of the memory controller 20 through the control line 29, and controls the operation of the entire memory controller 20. The controller 23 includes, for example, a central processing unit (CPU).

Here, the configuration of the memory system 10 illustrated in FIG. 2 is merely an example. Thus, the configuration of the memory system 10 is not limited to the illustrated configuration. For example, the memory controller 20 may include an address translation table (lookup table) for translating the logical address LBA transmitted from the host 40 into a particular physical address PBA.

[1-3. Block]

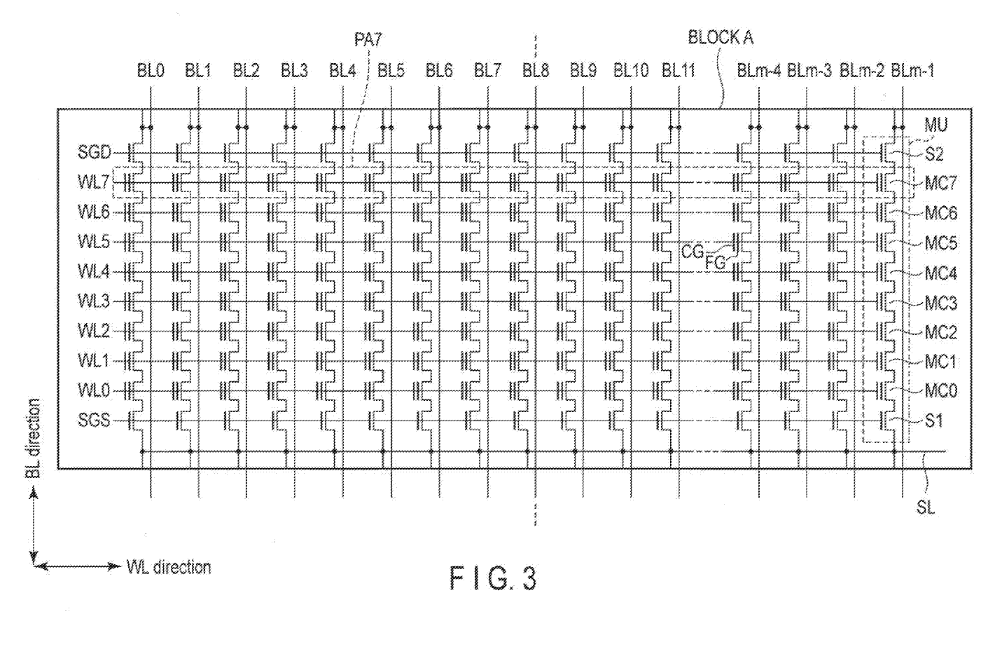

Referring to FIG. 3, the circuit configuration of the block 31 of the NAND memory 30 in FIG. 2 is described. Here, block A in FIG. 2 is cited as one example.

Block A includes a plurality of memory cell units MU arranged along word lines. Each of the memory cell units MU includes a NAND string (memory cell string) including eight memory cells MC0 to MC7 to which a current path is serially connected along a bit line, select transistor S1 on the source side which is connected to one end of the current path of the NAND string, and select transistor S2 on the drain side which is connected to the other end of the current path of the NAND string. Memory cells MC0 to MC7 each include a control gate CG and a floating gate FG. Here, the memory cell unit MU includes eight memory cells MC0 to MC7, but is not limited thereto. It suffices that the memory cell unit MU is constituted of at least two memory cells, for example, 56 memory cells or 32 memory cells.

One end of the current path of a select transistor S1 on the source side is connected to one end of the NAND string, and the other end is commonly connected to the source line SL. One end of the current path of a select transistor S2 on the drain side is connected to the other end of the NAND string, and the other end is connected to each of bit lines BL0 to BLm-1.

Word lines WL0 to WL7 are commonly connected to the control gates CG of the plurality of memory cells MC0 to MC7 arranged along the word line, respectively. A select gate line SGS is commonly connected to gate electrodes of a plurality of select transistors S1 arranged along the word line. A select gate line SGD is also commonly connected to gate electrodes of a plurality of select transistors S2 in the word line direction.

As shown in FIG. 3, each of word lines WL0 to WL7 has a page (PA). For example, page 7 (PA7) is provided on word line WL7, as surrounded by a broken line shown in the figure. Data is read and written for this page (PA). Thus, the page (PA) is a data read unit as well as a data write unit. Data is collectively erased in unit of block A. Thus, the block is a data erase unit.

[1-4. First and Second Block Lists]

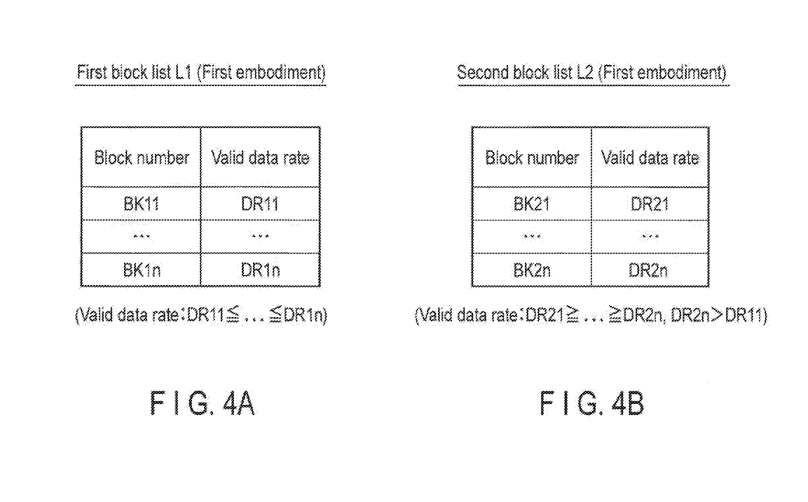

Referring to FIGS. 4A and 4B, the first and second block lists L1 and L2 according to the first embodiment are described in detail. The first and second block lists L1 and L2 are lists each indicating block information of blocks (garbage collection source blocks) from which data can be transferred.

As shown in FIG. 4A, block number and valid data ratio (first valid data ratio) of each block are shown in the first block list L1. For example, block number BK11 and valid data ratio DR11 of the block corresponding to block number BK11 are shown at the top of the first block list L1. Moreover, the block numbers of n blocks (n is a natural number of 2 or more) are sorted in ascending order of the valid data ratio (DR11 ≦ . . . ≦DR1n [first threshold value]) in the first block list L1. As described, the memory controller 20 manages a first group of blocks with the valid data ratio less than or equal to a first threshold value DR1n, in the first block list L1.

As shown in FIG. 4B, block numbers and valid data ratio (second valid data ratio) of each block are shown in a second block list L2. For example, block number BK21 and valid data ratio DR21 of the block corresponding to block number BK21 are shown at the top of second block list L2. The block numbers of n blocks are sorted in descending order of valid data ratio (DR21≧ . . . ≧ DR2n [second threshold value]) in the second block list L2.

Valid data ratio DR2n, which is the least in the second block list L2, is greater than valid data ratio DR1n, which is the greatest in the first block list L1 (DR2n>DR1n). Thus, the block number of the block having a greater valid data ratio than the blocks in the first block list L1 is shown in the second block list L2. In other words, the second block list L2 is a list indicating a block number of a block having a valid data ratio greater than the blocks in the first block list L1. As described, the memory controller 20 manages a second group of blocks having the valid data ratio greater than or equal to the second threshold value DR2n in the second block list L2.

Here, the “valid data ratio” refers to a ratio of valid data stored in a block to a storage capacity of the block in the first and second block lists L1 and L2. For example, the valid data ratio refers to a ratio of the number of clusters corresponding to valid data VD to the number of clusters which can be written in a block. The “valid data (VD)” refers to a data to be written in a block to which data may be transferred during the garbage collection. The “block number (block information)” is information by which a block can be identified (for example, physical block address PBA).

Here, the structures of the first and second block lists L1 and L2 are not limited to those shown in FIGS. 4A and 4B. For example, the number of valid data units may be used instead of the valid data ratio. Moreover, the valid data ratio is unnecessary if a corresponding valid data ratio can be referred to using a block number. For example, if a table indicating the number of valid data (number of valid clusters) of all the blocks 31 is provided, the number of valid data of a block can be determined from the block number by causing the memory controller 20 to refer to the table. Thus, in such a case, the valid data ratio is unnecessary in the first and second block lists L1 and L2. It suffices that only the block numbers arranged in the same manner on the basis of the valid data ratio are indicated.

Further, the first block list L1 and the second block list L2 are separately controlled in the above embodiment, but contents of the first block list L1 and the second block list L2 may be managed in one list.

[2. Operation]

Next, the operation of the memory system 10 according to the first embodiment is described.

[2-1. Generating and Updating Processing of Second Block List L2]

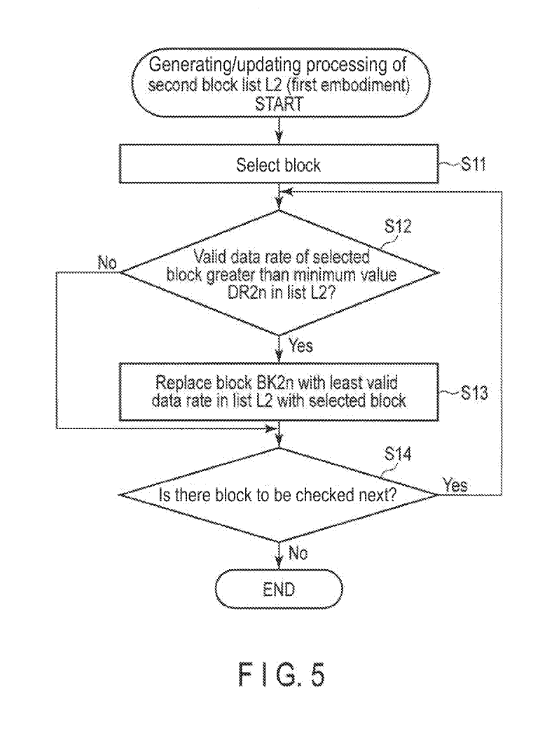

Referring to FIG. 5, generating and updating processing of the second block list L2 according to the first embodiment is described.

In step S11, the memory controller 20 selects one block from the NAND memory 30.

In step S12, the memory controller 20 determines whether the valid data ratio of the block selected in step S11 is greater than valid data ratio DR2n which is the least in the second block list L2. If the valid data ratio of the selected block is less than the valid data ratio DR2n (No in S12), the process proceeds to step S14.

In step S13, if the valid data ratio of the selected block is greater than the valid data ratio DR2n (Yes in S12), the memory controller 20 replaces the block BK2n with the least valid data ratio in the second block list L2 with the selected block. More specifically, in this case, the memory controller 20 refers to the second block list L2, and replaces the block BK2n with the valid data ratio DR2n which is the least in the second block list L2 with the selected block. The new block is sorted in the second block list L2 in accordance with the valid data ratio of the block.

In step S14, the memory controller 20 determines whether there is a block to be checked next. If there is a block to be checked next (Yes in S14), the memory controller 20 repeats steps S12 and S13. On the other hand, if there is no block to be checked (No in S14), the memory controller 20 ends the operation.

Here, the processing shown in FIG. 5 is not limited to the generation of the second block list L2. The second block list L2 can be properly updated by repeating a similar operation even after the second block list L2 has been generated.

[2-2. Garbage Collection Processing]

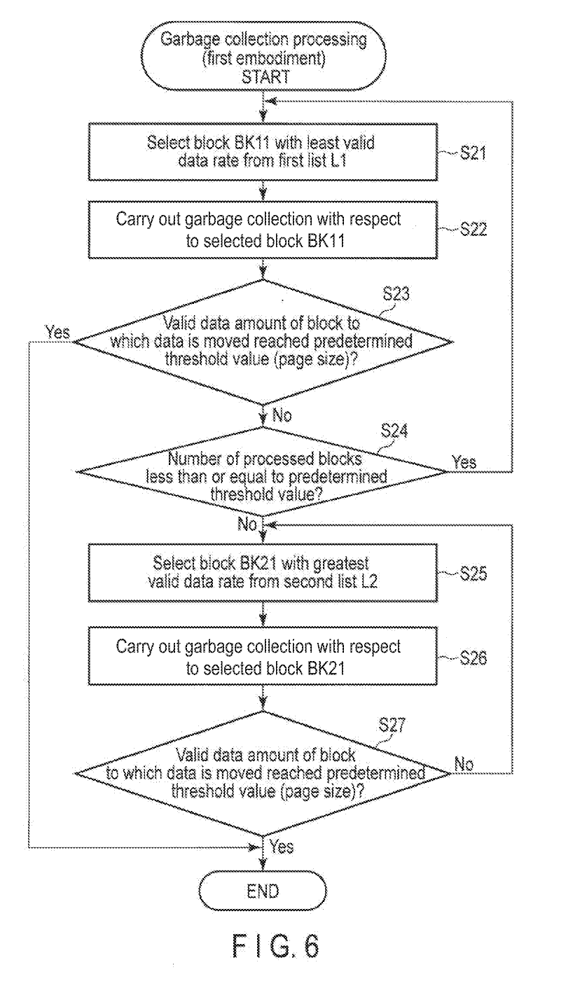

Referring to FIG. 6, garbage collection processing of the memory system 10 according to the first embodiment is described.

In step S21, the memory controller 20 selects the block BK11 with the least valid data ratio from the first block list L1. More specifically, the memory controller 20 refers to the first block list L1, and selects the block BK11 having the least valid data ratio DR11.

In step S22, the memory controller 20 carries out the garbage collection processing with respect to the selected block BK11.

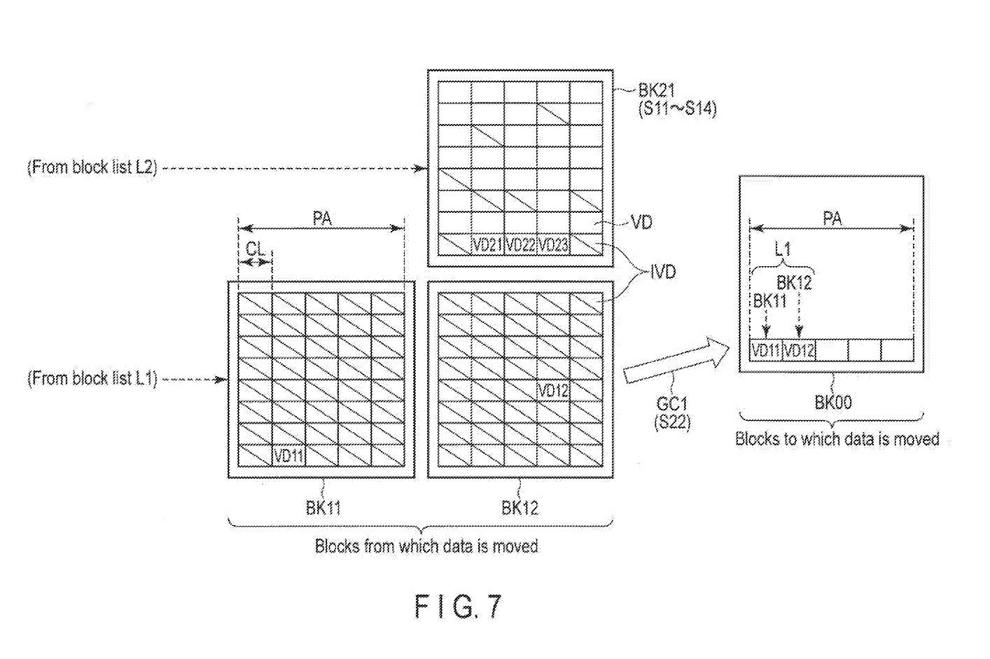

For example, as shown in FIG. 7, the memory controller 20 writes valid data VD11 in the selected block BK11 in block BK00 by unit of cluster CL. Here, as shown in FIG. 7, the page PA corresponds to five clusters CL. The clusters CL with an oblique line in FIG. 7 correspond to invalid data IVD. The “invalid data (IVD)” refers to data which is no longer referred to because the data is written (overwritten) in the same logical address LBA by the host 40, and the latest data is written in another block.

Referring to FIG. 6, in step S23, the memory controller 20 determines whether the valid data amount of the block from which data is to be transferred reached a predetermined threshold value (page size), in order to cause the NAND memory 30 to write data by unit of page PA as described above.

As shown in, for example, FIG. 7, the memory controller determines whether the valid data amount of data to be transferred reached one page size. In this regard, the valid data amount of data to be transferred is only valid data VD11 (equivalent to one cluster CL) in the block BK11. Thus, in this case, the memory controller 20 determines that the valid data amount has not reached the page size (No in S23). On the other hand, if the valid data amount reached the predetermined threshold value (Yes in S23), this operation ends.

Referring to FIG. 6, in step S24, the memory controller 20 determines whether the number of processed blocks is less than or equal to a predetermined threshold value.

For example, it is assumed that the threshold value is two. In this case, in the example shown in FIG. 7, a block on which the garbage collection processing has been performed is only the block BK11, which is the first block in the first block list L1. In this case, since the number of processed blocks is one, the memory controller 20 determines that the number of processed blocks is less than or equal to two, which is the threshold value (Yes in S24). In this case, the process returns to step S21, and the above operation is repeated. That is, the memory controller 20 writes valid data VD12 in the block BK12 next selected from the first block list L1 in the same page PA of the block BK00 to which data has been transferred.

Referring to FIG. 6, in step S25, if the number of processed blocks is not less than or equal to the threshold value (No in S24), the memory controller 20 selects block BK21 with the greatest valid data ratio from the second block list L2 as a block from which data is transferred. In other words, in this case, the memory controller 20 switches a block list from which a block to be subjected to the garbage collection is selected, from the first block list L1 to the second block list L2, and continues the garbage collection.

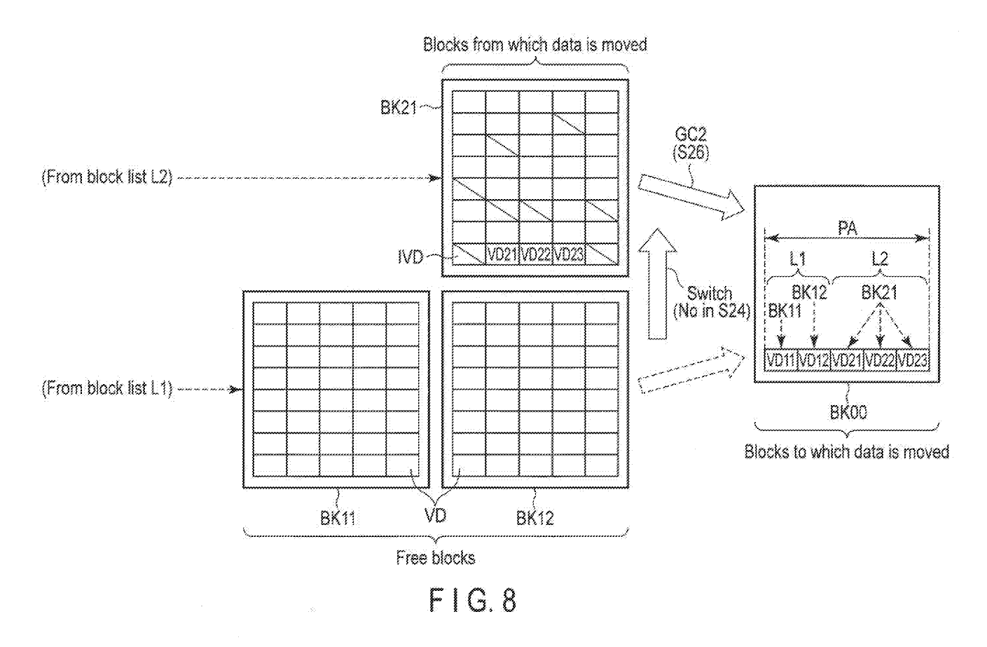

For example, as shown in FIG. 8, if valid data VD12 in the block BK12 is written in block BK00 to which data are to be transferred, the number of processed blocks during the garbage collection is two. Thus, in this case, the memory controller 20 determines that the number of processed blocks is not less than or equal to the threshold value (No in S24), and switches the block list from which block to be subjected to the garbage collection is selected, from the first block list L1 to the second block list L2. The memory controller 20 selects the block BK21 with the greatest valid data ratio from the second block list L2 as a block to be subjected to the garbage collection.

Here, all valid data in the blocks BK11 and BK12 are moved by moving the valid data VD11 and VD12 to the block BK00. Thus, the blocks BK11 and BK12 can be used as free blocks in which all pages PA are writable.

Referring to FIG. 6, in step S26, the memory controller 20 carries out the garbage collection processing with respect to the selected block BK21.

For example, as shown in FIG. 8, the memory controller 20 writes valid data VD21 to VD23 in the selected block BK21 in the same page PA of block BK00 to which the data has been transferred.

Referring to FIG. 6, in step S27, the memory controller 20 determines whether the valid data amount of the block to which the data are to be transferred has reached a predetermined threshold value (page size). If the valid data amount of the block to which data are to be transferred has reached the predetermined threshold value (Yes in S26), this operation ends.

As shown in FIG. 8, the memory controller 20 determines whether the valid data amount of the block BK00 to which data are to be transferred has reached one page size. Here, the valid data in the block BK00 to which data are to be transferred is valid data VD11 and VD12 (equivalent to two clusters CL) from the blocks BK11 and BK12, and the valid data VD21 to VD23 (equivalent to three clusters CL) from the block BK21. Thus, in this case, the memory controller 20 determines that the valid data amount of the block BK00 to which data are to be transferred has reached the page size (Yes in S26), and this operation ends.

On the other hand, if the valid data amount in the block to which data are to be transferred has not reached the predetermined threshold value (No in S27), the process returns to step S25, and the memory controller 20 repeats the above operation.

### 3. Advantageous Effects

As has been described above, at least the following advantageous effects (1) and (2) can be obtained from the configuration and operation of the memory system 10 according to the first embodiment.

(1) The write time required for the garbage collection can be reduced, and the garbage collection can be completed within a write time required by the host 40.

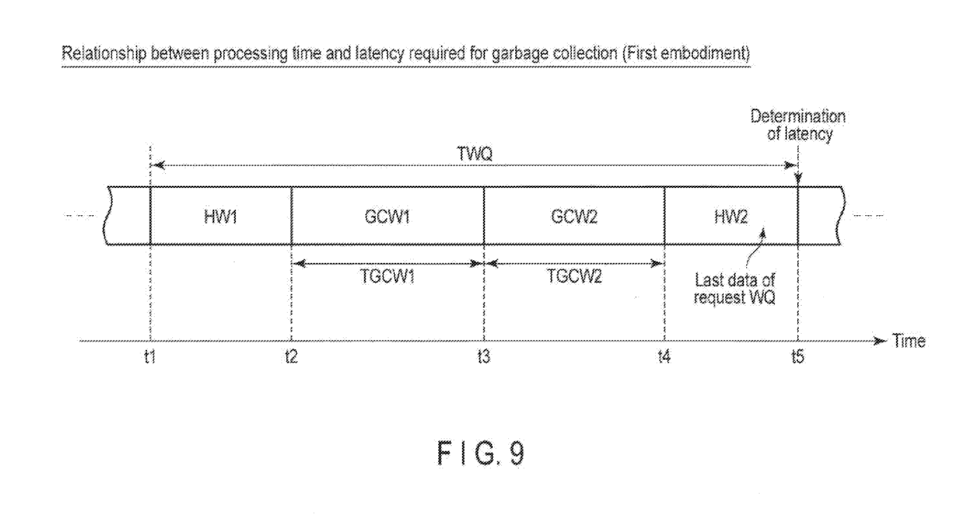

As shown in FIG. 9, in the memory system 10 according to the first embodiment, for example, host writes HW1 and HW2 for writing write data transmitted from the host 40 in the NAND memory 30, and GC writes GCW1 and GCW2 accompanied by data transfer for forming the free block are alternately performed. For example, at times t1 and t4, the memory controller 20 writes the write data transmitted from the host 40 in the free block of the NAND memory 30. During times t2 to t4, the memory controller 20 performs the garbage collection accompanied by the data transfer for forming the free block. At this moment, the last data of a write request WQ is written in the NAND memory 30 in host write HW2.

Thus, write times TGCW1 and TGCW2 required for GC writes GCW1 and GCW2 need to be determined in order to determine overall latency TWQ for the write request WQ from the host 40. In this regard, the write times TGCW1 and TGCW2 correspond to a time for transferring the valid data VD from an original block to a destination block.

For example, to reduce the write times TGCW1 and TGCW2, a block with many valid data VD (block with a high valid data ratio) needs to be selected as a block from which data is transferred. The block with many valid data VD includes many valid data VD that can be transferred. Thus, the data size of the valid data VD that is to be transferred from the block amounts to a write unit (for example, page size). Accordingly, the write times TGCW1 and TGCW2 required for the garbage collection depend on the time to fill a predetermined data size (for example, page size) with the data to be transferred.

Therefore, the memory system 10 according to the first embodiment includes the first block list L1 in which blocks with a low valid data ratio are registered, and the second block list L2 in which blocks with a high valid data ratio are registered (FIGS. 4A and 4B). In the above configuration, the memory controller 20 first performs first garbage collection GC1 and selects the blocks BK11 and BK12 from the first block list L1 and copies the valid data VD11 and VD12 of blocks BK11 and BK12 (S21 and S22 in FIG. 6, and FIG. 7). The memory controller 20 then performs second garbage collection GC2, and selects the block BK21 from the second block list L2 and copies the valid data VD21 to VD23 (S25 and S26 in FIG. 6, and FIG. 8).

As a result of the garbage collections GC1 and GC2, the valid data VD11, VD12, and VD21 to VD23 of blocks BK11, BK12, and BK21 are written in the block BK00. Thus, the data size of the valid data VD11, VD12 and VD21 to VD23 satisfies a write unit (for example, page size).

Accordingly, a block with many valid data for the garbage collection GC2 can be selected from the second block list L2. This can reduce the write times TGCW1 and TGCW2 required for the garbage collection further. In addition, since this can reduce the write times TGCW1 and TGCW2 required for the garbage collection further, the overall latency TWQ for the write request WQ can be reduced.

(2) Invalid data write can be prevented, allowing the NAND memory 30 to have a greater lifetime.

This advantageous effect is described by comparing the first embodiment with a comparative example.

### A) Comparative Example

A case where the garbage collection is performed using only blocks with a low valid data ratio is described as a comparative example.

If the garbage collection is performed with respect to only blocks with a low valid data ratio, the size of valid data to be transferred may be small. As many blocks are selected for the garbage collection, many blocks can be free blocks as the valid data therein are transferred to a destination block.

However, if the garbage collection is performed with respect to only blocks with low valid data, the data size may not satisfy a write unit (page size), even if several blocks are selected for the garbage collection. In such a case, for example, invalid data needs to be further written to satisfy the write unit.

Writing such invalid data is unnecessary writing. Such an unnecessary writing may reduce a lifetime of a memory cell of a NAND memory, which generally has a limited number of writing times.

As described above, in the memory system according to the comparative example, as invalid data writing may be needed, the lifetime of the NAND memory may be reduced.

### B) First Embodiment

The memory system 10 according to the first embodiment can select a single block BK21 to satisfy the data size of the page PA, i.e., the valid data VD21 to VD23, from the second block list L2 including blocks with a high valid data ratio, as described in FIG. 8.

As described above, the memory system 10 according to the first embodiment does not need to perform writing the invalid data, and allows the NAND memory 30 to have a greater lifetime.

In addition, in the comparative example, more invalid data must be written in order to reduce the write time by limiting the number of processed blocks with low valid data ratio.

The memory controller 20 according to the first embodiment switches a block from which valid data is transferred from the first block list L1 to the second block list L2 based on the number of processed blocks, and performs the garbage collection (No in S24 of FIG. 6, and FIG. 8).

As described above, the reduction in the write time by limiting the number of processed blocks with a low valid data ratio can be achieved without writing invalid data by selectively switching the block from which data is transferred from the first block list L1 to the second block list L2.

### Second Embodiment

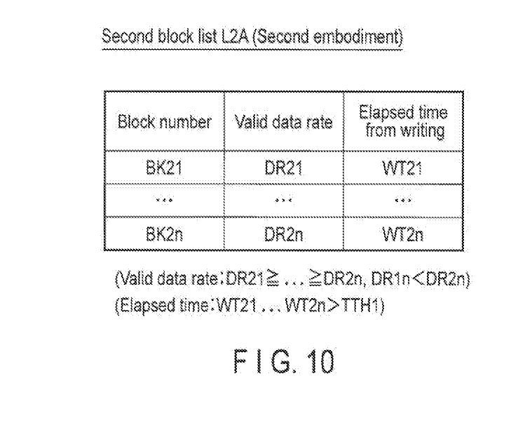

Referring to FIGS. 10-12, a memory system 10 according to a second embodiment will be described. The second embodiment relates to one example in which the block list from which the block to be subjected to the garbage collection is switched further based on an elapsed time from the writing of the valid data. In the description below, description overlapping that of the first embodiment is omitted.

[Configuration]

[Second Block List L2A]

Referring to FIG. 10, a second block list L2A according to the second embodiment is described. As shown in FIG. 10, the second block list L2A according to the second embodiment further includes elapsed times WT21 to WT2n from the writing of the valid data in the second block list L2 of the first embodiment. The “elapsed time from the writing” refers to a time elapsed from when valid data have been written in each of blocks BK21 to BK2n in the second block list L2A to when each of the blocks BK21 to BK2n has been registered or updated in the second block list L2A. It should be noted that each of elapsed times WT21 to WT2n is greater than a predetermined threshold value (first threshold value) TTH1 (WT21, . . . , WT2n>TTH1). The predetermined threshold value TTH1 is determined in advance, and the value is, for example, approximately several tens of hours.

Since the other configuration is substantially the same as that in the first embodiment, it is not described in detail.

[Operation]

[Generating and Updating Processing of Second Block List L2A]

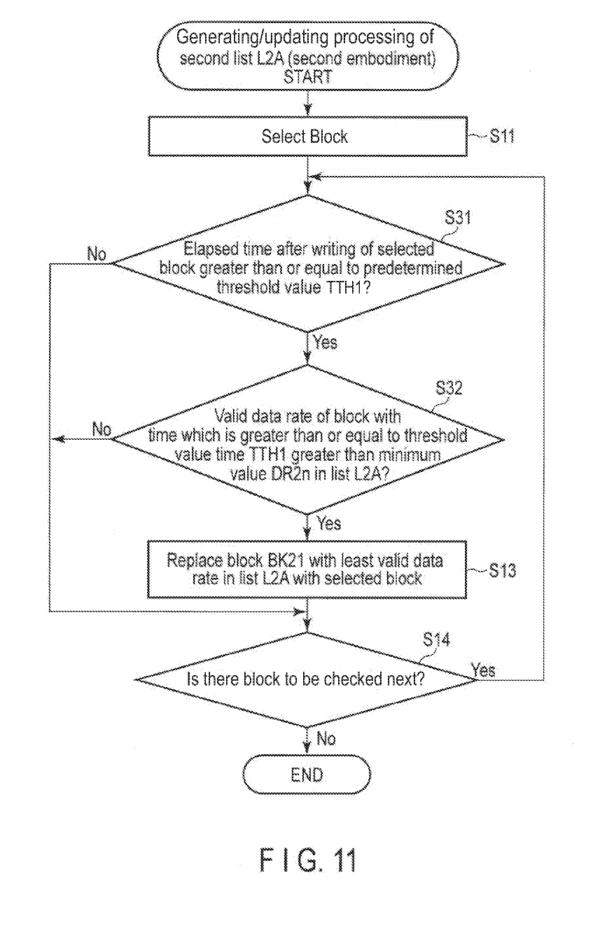

Referring to FIG. 11, the generating and updating processing of the second block list L2A according to the second embodiment is described.

As shown in FIG. 11, the generating and updating processing of the second block list L2A according to the second embodiment includes steps S31 and S32 instead of step 12 in the first embodiment.

In step S31, the memory controller 20 determines whether the elapsed time after data has been written in a selected block is greater than or equal to the predetermined threshold value TTH1. If the elapsed time is less than the predetermined threshold value TTH1 (No in S31), the memory controller 20 carries out step S14 in the same manner.

In step S32, if the elapsed time is greater than or equal to the predetermined threshold value TTH1 (Yes in S31), the memory controller 20 determines whether a valid data ratio of a block with a time greater than or equal to the threshold value TTH1 is greater than the minimum value DR2n in the second block list L2A.

In step S13, if the valid data ratio of the block with the time greater than or equal to the threshold value TTH1 is greater than the minimum value DR2n in the second block list L2A (Yes in S32), the memory controller 20 replaces the block BK2n with the selected block in the same manner.

On the other hand, if the valid data ratio of the block with the time greater than or equal to the threshold value TTH1 is less than the minimum value DR2n in the second block list L2A (No in S32), the memory controller 20 carries out step S14 in the same manner.

The second block list L2A that lists blocks having a high valid data ratio and an elapsed time longer than the fixed time (TTH1) can be generated and updated by repeating such operations.

[Garbage Collection Processing]

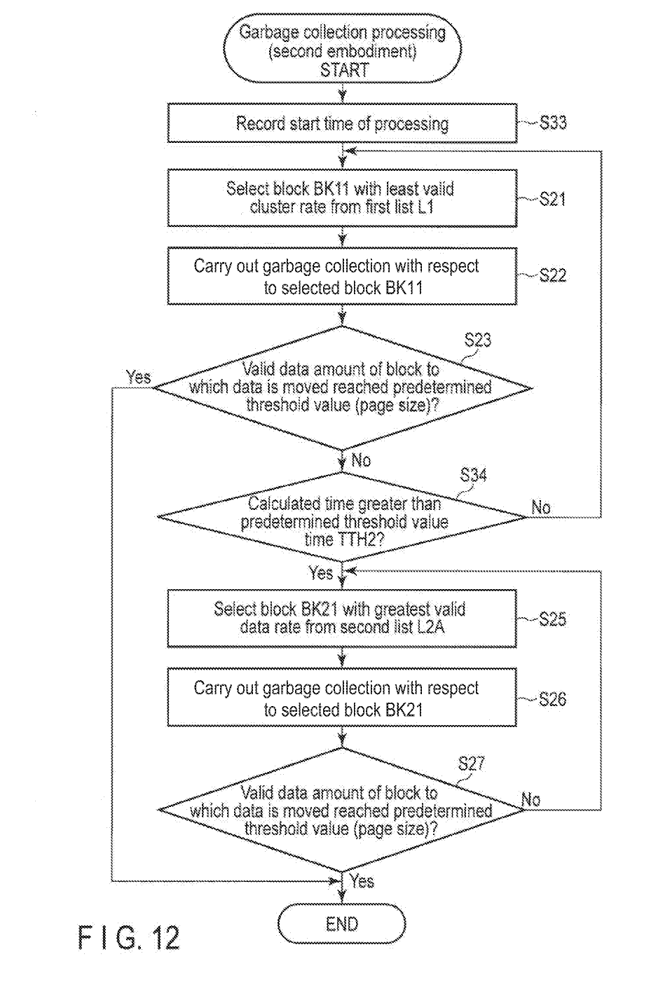

Referring to FIG. 12, garbage collection processing of the memory system 10 according to the second embodiment is described.

As shown in FIG. 12, the garbage collection processing according to the second embodiment includes steps S33 and S34.

In step S33, the memory controller 20 records the time at which the process starts. More specifically, the memory controller 20 stores the time at which the garbage collection processing starts in a predetermined memory. The recorded time is used in step S34.

In step S34, the memory controller 20 determines whether the elapsed time is greater than a threshold value (second threshold value) TTH2. The threshold value TTH2 is a threshold value preset in order to complete the garbage collection within a given time. The threshold value TTH2 is equivalent to approximately 70% of the upper limit of write times TGCW1 and TGCW2 required for the garbage collection shown in FIG. 9, and, for example, approximately several tens of milliseconds. Thus, the threshold value TTH2 is less than the threshold value TTH1 used when the second block list L2A is generated and updated (threshold value: TTH2<TTH1).

More specifically, the memory controller 20 calculates a difference between the start time of the processing recorded in step S33 and the time determined in step S34, and calculates an elapsed time from the start. The memory controller 20 compares the calculated elapsed time from the start with the threshold value TTH2. The memory controller 20 determines whether the elapsed time is greater than the threshold value TTH2 on the basis of the result of the comparison.

If the elapsed time is greater than predetermined threshold value TTH2 (Yes in S34), the memory controller 20 carries out step 25 in the same manner. If the elapsed time is less than predetermined threshold value TTH2 (No in S34), the memory controller 20 carries out step 21 in the same manner.

Since the other operations are substantially the same as the ones in the first embodiment, they are not described in detail.

### Advantageous Effects

As described above, at least the following advantageous effects (1) and (2) can be obtained from the configuration and operation of the memory system 10 according to the second embodiment. Moreover, advantageous effect (3) can be obtained according to the second embodiment.

(3) Reliability of data stored in the NAND memory 30 can be improved.

The second block list L2A according to the second embodiment further includes the elapsed times WT21 to WT2n from the writing. Each of the elapsed times WT21 to WT2n is greater than the predetermined threshold value TTH1 (FIG. 10).

In this regard, in the NAND memory 30, an electrical charge at a floating gate FG of the memory cell MC decreases little by little after the writing, and bit errors gradually increase. Thus, valid data stored for a long time from the writing may need to be rewritten before an error can be no longer corrected.

In the second embodiment, a block with data of the elapsed time greater than predetermined threshold value TTH1 is selected (S25 in FIG. 12). Moreover, garbage collection is performed with respect to the selected block, and data in the selected block is rewritten to another block (S26 in FIG. 12).

As shown above, data of the NAND memory 30 can be stored more securely by performing the garbage collection with respect to a block having data with a great elapsed time selected from the second block list L2A. As a result, data stored in the NAND memory 30 can be rewritten before an error can be no longer corrected, and the reliability of the data stored in the NAND memory 30 can be improved.

### Third Embodiment

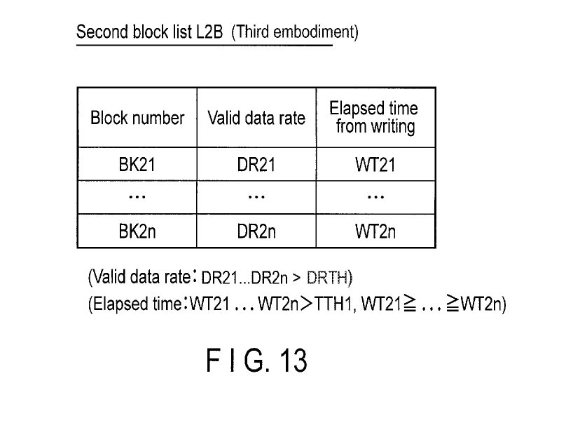

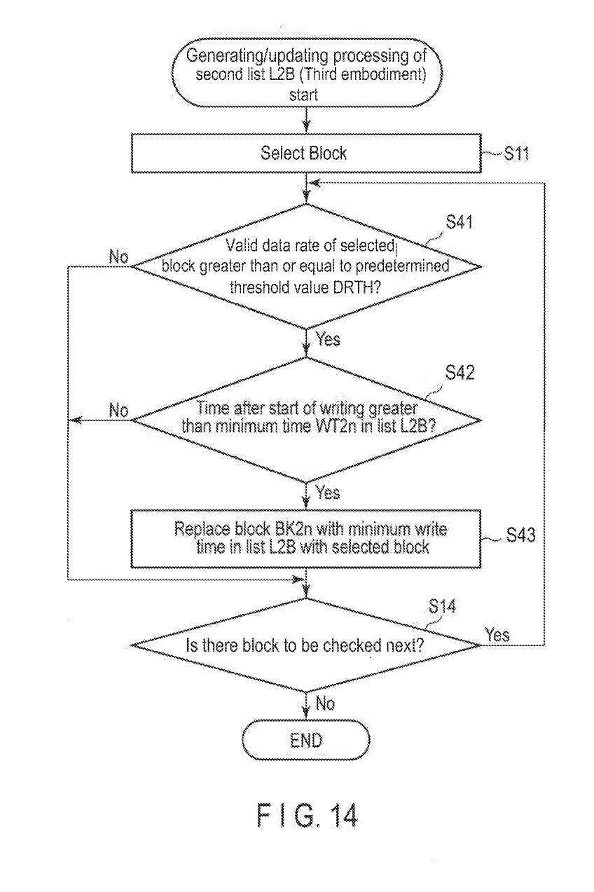

Referring to FIGS. 13 and 14, a memory system 10 according to a third embodiment is described. In the description below, description overlapping the first and second embodiments is omitted.

[Configuration]

[Second Block List L2B]

Referring to FIG. 13, a second block list L2B according to the third embodiment is described. As shown in FIG. 13, in the second block list L2B according to the third embodiment, elapsed times WT21 to WT2n are sorted in descending order (WT21≧ . . . ≧WT2n) in comparison to the second embodiment. Moreover, any of valid data ratios DR21 to DR2n is greater than predetermined threshold value DRTH (DR21 to DR2n>DRTH).

Since the other configuration is substantially the same as in the second embodiment, it is not described in detail.

[Operation]

[Generating and Updating Processing of Second Block List L2B]

Referring to FIG. 14, generating and updating processing of the second block list L2B according to the third embodiment is described.

As shown in FIG. 14, the generating and updating processing of the second block list L2B according to the third embodiment includes steps S41 to S43 instead of steps S31, S32 and S13 in the second embodiment.

In step S41, the memory controller 20 refers to the second block list L2B, and determines whether the valid data ratio of the selected block is greater than or equal to the predetermined threshold value DRTH. If the valid data ratio of the selected block is less than the predetermined threshold value DRTH (No in S41), the memory controller 20 carries out step S14 in the same manner.

If the valid data ratio of the selected block is greater than or equal to the predetermined threshold value DRTH in step S42 (Yes in S41), the memory controller 20 determines whether a time elapsed after the start of writing is greater than the minimum time WT2n in the second block list L2B. If the time elapsed after the start of writing is less than the minimum time WT2n in the second block list L2B (No in S42), the memory controller 20 carries out step S14 in the same manner.

If the time elapsed after the start of writing is greater than the minimum time WT2n in the second block list L2B (Yes in S42), the memory controller 20 replaces the block BK2n with the minimum write time in the second block list L2B with the selected block in step S43.

Since the other operations are substantially the same as in the second embodiment, they are not described in detail.

### Advantageous Effects

As described above, at least the following advantageous effects (1) to (3) can be obtained from the configuration and operation of the memory system 10 according to the third embodiment.

Moreover, the memory system 10 according to the third embodiment includes the second block list L2B in which elapsed times WT21 to WT2n are sorted in descending order (WT21 ≧ . . . ≧WT2n) (FIG. 13).

Thus, it is advantageous in that the reliability of the data stored in the NAND memory 30 can be further improved.

### Fourth Embodiment

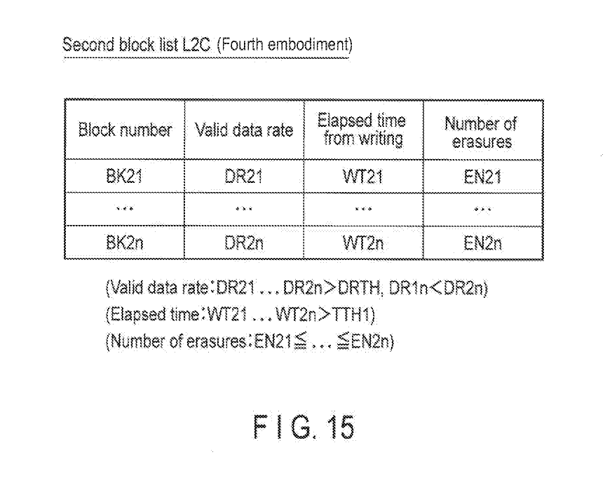

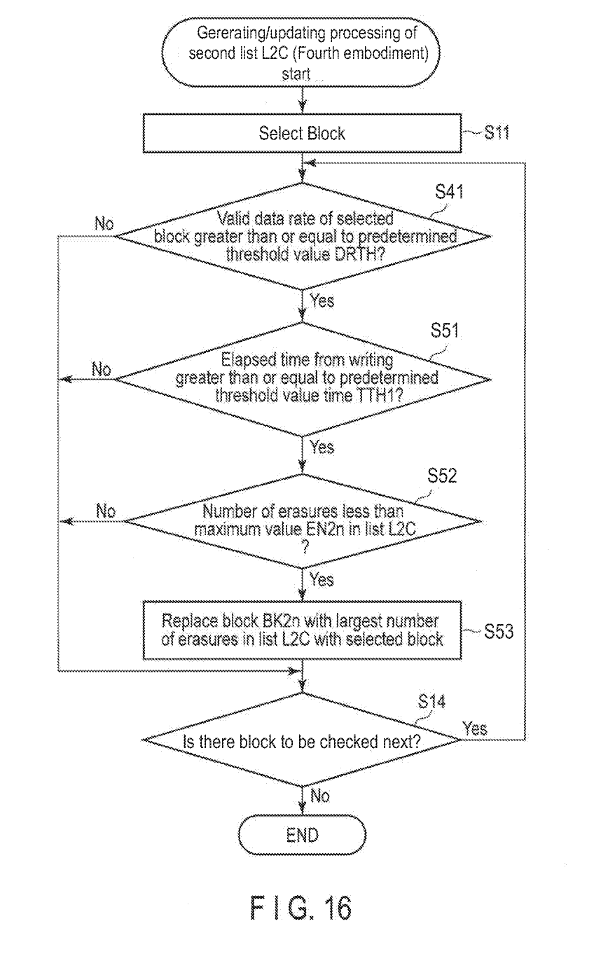

Referring to FIGS. 15 and 16, a memory system 10 according to a fourth embodiment is described. In the description below, description overlapping the first, second, and third embodiments is omitted.

[Configuration]

[Second Block List L2C]

Referring to FIG. 15, a second block list L2C according to the fourth embodiment is described.

As shown in FIG. 15, the second block list L2C according to the fourth embodiment further includes the numbers of erasures EN21 to EN2n in addition to the second embodiment. The numbers of erasures EN21 to EN2n are sorted in ascending order (EN21≦ . . . ≦EN2n).

Since the other configuration is substantially the same as that of the third embodiment, it is not described in detail.

[Operation]

[Generating and Updating Processing of Second Block List L2C]

Referring to FIG. 16, generating and updating processing of the second block list L2C according to the fourth embodiment is described.

As shown in FIG. 16, the generating and updating processing of the second block list L2C according to the fourth embodiment includes steps S51 to S53 instead of steps S42 and S43 in the third embodiment.

In step S51, the memory controller 20 determines whether an elapsed time from writing of the selected block is greater than or equal to the predetermined threshold value TTH1. If the elapsed time from writing is less than the predetermined threshold value TTH1 (No in S51), the memory controller 20 carries out step S14 in the same manner.

If the elapsed time from writing is greater than or equal to the predetermined threshold value TTH1 in step S52 (Yes in S51), the memory controller 20 determines whether the number of erasures of the selected block is less than the maximum value EN2n in the second block list L2C. If the number of erasures is larger than the maximum value EN2n in the second block list L2C (No in S52), the memory controller 20 carries out step S14.

If the number of erasures is less than the maximum value EN2n in the second block list L2C in step S53 (Yes in S52), the memory controller 20 replaces the block BK2n with the largest number of erasures in the second block list L2C with the selected block.

Since the other operations are substantially the same as those in the third embodiment, they are not described in detail.

### Advantageous Effects

As has been described above, at least the following advantageous effects (1) to (3) can be obtained from the configuration and operation of the memory system 10 according to the fourth embodiment.

Moreover, the memory system 10 according to the fourth embodiment includes the second block list L2C that further includes the numbers of erasures EN21 to EN2n (FIG. 15). The memory controller 20 performs garbage collection on the basis of the second block list L2C in the same manner.

Thus, according to the fourth embodiment, a block not selected in the first block list L1 because of its small number of erasures and its high valid data ratio can be selected for the garbage collection by using the second block list L2C. As a result of the garbage collection, the block selected from the second block list L2C becomes a free block in the same manner. Thus, according to the fourth embodiment, wear leveling can be performed by changing a block with the small number of erasures to a free block and reusing it.

### Modification Example

Although the above description is provided using the first to fourth embodiments, the configuration, and operation, etc., are not limited to the description. They can be modified as necessary.

For example, what is managed by the first and second block lists L1 and L2 is not limited to the above. For example, the memory controller 20 can also manage the number of valid data and the data size of the valid data, etc., in the second block list L2, instead of the valid data ratio.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory device, comprising:
a nonvolatile memory unit including a plurality of blocks; and
a memory controller configured to determine target blocks for garbage collection, the target blocks including a first block that has a valid data ratio greater than zero and equal to or smaller than a predetermined value and a second block that has a valid data ratio greater than the predetermined value, and transfer valid data in the target blocks to another block during the garbage collection.

2. The memory device according to claim 1, wherein
a block that has the smallest valid data ratio of a plurality of blocks that have a valid data ratio greater than zero and equal to or smaller than the predetermined value is determined to be the first block.

3. The memory device according to claim 1, wherein
a block that has the largest valid data ratio of a plurality of blocks that have a valid data ratio greater than the predetermined value is determined to be the second block.

4. The memory device according to claim 1, wherein
the memory controller is further configured to maintain a first list containing one or more blocks having a valid data ratio that is greater than zero and equal to or smaller than the predetermined value, and a second list containing one or more blocks having a valid data ratio that is greater than the predetermined value, and
one of the blocks in the first list is determined to be the first block, and one of the blocks in the second list is determined to be the second block.

5. The memory device according to claim 4, wherein
the memory controller is further configured to
determine whether or not a data size of the valid data in the first block is equal to or greater than a predetermined size, and
when the data size is smaller than the predetermined size, determine one or more other blocks in the first list to be the target blocks for the garbage collection.

6. The memory device according to claim 5, wherein
the memory controller is further configured to determine the number of blocks in the first list, that are determined to be the target blocks, and
when the number is greater than a predetermine number, the memory controller determines no other block in the first list to be the target block for the garbage collection.

7. The memory device according to claim 4, wherein
the second list contains one or more blocks that have a valid data ratio greater than the predetermined value and indicates an elapsed time, which is a time that has passed since oldest valid data was written therein, greater than a predetermined value.

8. The memory device according to claim 7, wherein
a block in the second list, that has the largest elapsed time is determined to be the second block.

9. The memory device according to claim 4, wherein
a block in the second list, that has been subjected to erasing the least number of times is determined to be the second block.

10. The memory device according to claim 1, wherein
the nonvolatile memory unit includes a NAND-type flash memory.

11. A method for managing data stored in a nonvolatile memory unit that includes a plurality of blocks, the method comprising:
determining target blocks for garbage collection, including a first block that has a valid data ratio greater than zero and equal to or smaller than a predetermined value and a second block that has a valid data ratio greater than the predetermined value; and
transferring valid data in the target blocks to another block.

12. The method according to claim 11, wherein
a block that has the smallest valid data ratio of a plurality of blocks that have a valid data ratio greater than zero and equal to or smaller than the predetermined value is determined to be the first block.

13. The method according to claim 11, wherein
a block that has the largest valid data ratio of a plurality of blocks that have a valid data ratio greater than the predetermined value is determined to be the second block.

14. The method according to claim 11, further comprising:
maintaining a first list containing one or more blocks having a valid data ratio that is greater than zero and equal to or smaller than the predetermined value and a second list containing one or more blocks having a valid data ratio that is greater than the predetermined value, wherein
one of the blocks in the first list is determined to be the first block, and one of the blocks in the second list is determined to be the second block.

15. The method according to claim 14, further comprising:
determining whether or not a data size of the valid data in the first block is equal to or greater than a predetermined size; and
when the data size is smaller than the predetermined size, determining one or more other blocks in the first list to be the target blocks for the garbage collection.

16. The method according to claim 15, further comprising:
determining the number of blocks in the first list, that are determined to be the target blocks; and
when the number is greater than a predetermine number, no other block in the first list is determined to be the target block for the garbage collection.

17. The method according to claim 14, wherein
the second list contains one or more blocks that have a valid data ratio greater than the predetermined value and indicates an elapsed time, which is a time that has passed since oldest valid data was written therein, greater than a predetermined value.

18. The method according to claim 17, wherein
a block in the second list, that has the largest elapsed time is determined to be the second block.

19. The method according to claim 14, wherein
a block in the second list, that has been subjected to erasing the least number of times is determined to be the second block.

20. The method according to claim 11, wherein
the nonvolatile memory unit includes a NAND-type flash memory.
